(19) United States
(12) Patent Application Publication
(10) Pub. No.: US 2007/0195888 A1
(43) Pub. Date: Aug. 23, 2007

(54) Intra-Frame Prediction Processing

(75) Inventor: Kiumars Sabeti, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA TECHNOLOGIES, INC., Taipei (TW)

(21) Appl. No.: 11/566,713

(22) Filed: Dec. 5, 2006

Related U.S. Application Data
(60) Provisional application No. 60/774,760, filed on Feb. 17, 2006.

(51) Int. Cl. H04N 11/04; H04N 7/12

(52) U.S. Cl. 375/240.24; 375/240.26

(57) ABSTRACT

Systems and methods for managing and processing macroblocks of video data are disclosed herein. In one embodiment, among others, a method is disclosed in which a frame of video data separated into a plurality of macroblocks is provided, wherein the macroblocks are arranged in a raster scan order. The method further includes changing the order that the macroblocks are to be processed. The order is changed from the raster scan order to a new order, wherein the new order includes processing at least two macroblocks simultaneously. After re-ordering the macroblocks, the method includes processing the at least two macroblocks.

### CROSS-REFERENCE TO RELATED APPLICATIONS

This application claims the benefit under 35 U.S.C. 119(e) of U.S. Provisional Application No. 60/774,760, filed Feb. 17, 2006, which is incorporated by reference in its entirety into the present disclosure.

### TECHNICAL FIELD

The present disclosure generally relates to processing video signals. More particularly, the disclosure relates to systems and methods for reducing the time needed for processing macroblocks during intra-frame prediction and deblocking calculations.

### BACKGROUND

The use of video pictures is widespread, particularly video pictures that are captured in digital form. For example, digital video is common with respect to broadcast television, DVDs, etc. Digital video can be stored on a particular media component (such as a DVD) and/or can be transferred via channels from one location to another. Since digital video includes such a large amount of data when first captured, it has been found that the original digital video signals can be compressed to reduce the size of the data and to ease the burden of storage media and transport channels.

Standards for digital video, such as the ITU-T Recommendation H.264, or Advanced Video Coding (AVC), use an accumulation of various compression techniques to efficiently compress data. For each frame of video data, the pixels can be divided into an array of macroblocks, where each macroblock has a size of 16×16 pixels and can be divided into 8×8 or 4×4 sub-blocks. A frame may have any number of macroblocks, depending primarily on the size, aspect ratio, and resolution of the video and the display screen on which the video is displayed. For high definition (HD) video, which can be displayed on an HD television (HDTV), the size of the frame is 1920×1088 pixels. When divided into 16×16 macroblocks, for example, HD video includes 120×68 macroblocks, which is a total of 8,160 macroblocks.

With respect to compression, some techniques for compressing data include prediction of pixels by comparing the luma and chroma values of the pixels with previously processed pixels. For example, with “inter-frame” prediction, pixels are compared with the pixels of another frame and residual values, which represent the difference between the predicted values and the actual values, are obtained. With “intra-frame” prediction, pixels are compared with other pixels within the same frame for determining the residual values. Both inter-frame and intra-frame prediction can be performed and then the method with the smallest residuals can be selected to provide loss-less coding of the original video signals using the fewest number of bits.

FIGS. 1A-1D illustrate four examples of intra-frame prediction for a 16×16 macroblock to be processed according to H.264. FIG. 1A illustrates a first prediction calculation, referred to as mode 0 (vertical), which uses the 16 pixels (H) adjacent to the top layer of pixels of the 16×16 macroblock being processed. The values for these adjacent pixels (H) from an above-positioned macroblock are already known from previous calculations. In mode 0, the values of each of the 16 pixels (H) are applied to the pixels in each respective column, as shown by the direction of the arrows in the drawing. FIG. 1B illustrates mode 1 (horizontal), in which the 16 pixels (V) from another macroblock adjacent to the leftmost column of pixels of the 16×16 macroblock being processed are known from previous calculations and applied in a horizontal direction to the pixels in each respective row. FIG. 1C illustrates mode 2 (DC), in which an average value of the 16 H pixels and 16 V pixels is calculated and applied to each pixel in the macroblock being processed. FIG. 1D illustrates mode 3 (plane), in which values are applied in a diagonal direction from the 16 H pixels and 16 V pixels. Also, values of 16 pixels (D) from another macroblock that is above and to the right of the macroblock being processed is applied to the lower right pixels in a diagonal direction.

Therefore, as seen in FIGS. 1A-1D, the macroblock being processed according to H.264 relies on three other macroblocks during intra-frame prediction. These other three macroblocks are shown in FIG. 2, where macroblock 10 represents the macroblock being processed. Macroblock 12 immediately to the left of macroblock 10, macroblock 14 immediately above macroblock 10, and macroblock 16 above and to the right of macroblock 10 are relied upon for providing prediction values. Since the values for macroblocks 12, 14, and 16 are already calculated, the values can be used to make predictions for macroblock 10 being processed. As mentioned above, after the prediction values are applied, residual values are calculated by determining the difference between the prediction values and the actual values. If intra-frame prediction provides better prediction values compared with inter-frame prediction, the intra-frame mode (FIGS. 1A-1D) that provides the best prediction values, based on the smallest residuals of the four modes, can be used as the values for macroblock 10 along with an indication of the mode used. These values can be stored or transmitted and later decoded to restore the original pictures using the residual values.

FIG. 3 illustrates the arrangement of 16×16 macroblocks for an HD video frame. As illustrated, the frame is 120 macroblocks wide and 68 macroblocks high for a total of 8,160 macroblocks. The macroblocks are processed in a raster scan order starting from the top left corner, proceeding along a row in sequential order, and then proceeding to the next rows, one at a time, until the last macroblock in position 8159 is processed. By continuing in the raster scan order, the particular macroblock 10 being processed has access to the macroblocks 12, 14, and 16 (FIG. 2) upon which it depends for prediction values. In this respect, the processing is performed 8,160 times, which can consume a relatively large portion of the time available between successive frames. Because of the large amount of time required to process all macroblocks, a need exists in the field of digital video to address these and other inadequacies of conventional processing techniques and to reduce video processing time.

### SUMMARY

Systems and methods for processing video data are disclosed herein. For example, in one embodiment of a system for managing macroblocks, the system comprises a placement device configured to create a plurality of macroblocks from a frame of video data. The system also includes a buffer separated into a plurality of registers, wherein each register is configured to store at least one macroblock. The system further comprises a plurality of processing units, where each processing unit is configured to process at least one macroblock. Also, the system includes memory configured to store results of macroblock processing performed by the processing units. The placement device is further configured to place the macroblocks in respective registers based on the position of the macroblocks within the frame.

In one embodiment, among others, pertaining to a method of the present disclosure, the method includes providing a frame of video data that is separated into a plurality of macroblocks. The macroblocks are arranged, for example, in a raster scan order. The method further includes changing the order that the macroblocks are to be processed. The order is changed from the raster scan order to a new order, wherein the new order includes processing at least two macroblocks simultaneously. The method further includes processing the macroblocks in the new order.

Other systems, methods, features, and advantages of the present disclosure will be apparent to one having skill in the art upon examination of the following drawings and detailed description. It is intended that all such additional systems, methods, features, and advantages be included within this description and protected by the accompanying claims.

### BRIEF DESCRIPTION OF THE DRAWINGS

Many aspects of the embodiments disclosed herein can be better understood with reference to the following drawings. The components in the drawings are not necessarily to scale, emphasis instead being placed upon clearly illustrating the principles of the present disclosure. Like reference numerals designate corresponding parts throughout the several views.

FIGS. 1A through 1D are examples of conventional intra-frame prediction techniques for a 16×16 macroblock.

FIG. 2 is a diagram showing a conventional example of the macroblocks that are depended upon to calculate predictions for a macroblock to be processed.

FIG. 3 is a diagram illustrating an example of an array of macroblocks including a conventional order in which the macroblocks are processed.

FIG. 4 is a diagram illustrating an example of an array of macroblocks including a re-ordered pattern according to the teachings of the present disclosure, including a new order in which the macroblocks are processed.

FIG. 5 is a block diagram of an embodiment of a macroblock processing device according to the teachings of the present disclosure.

FIG. 6 is a block diagram of an embodiment of the placement device shown in FIG. 5.

FIG. 7 is a flow chart illustrating an embodiment of a method for processing macroblocks according to the teachings of the present disclosure.

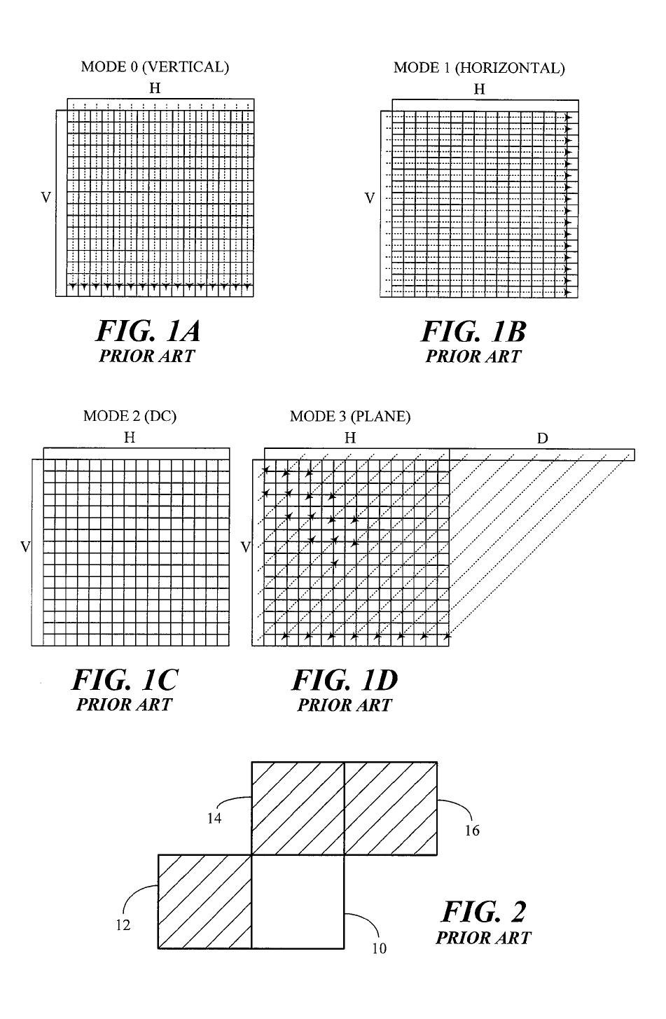

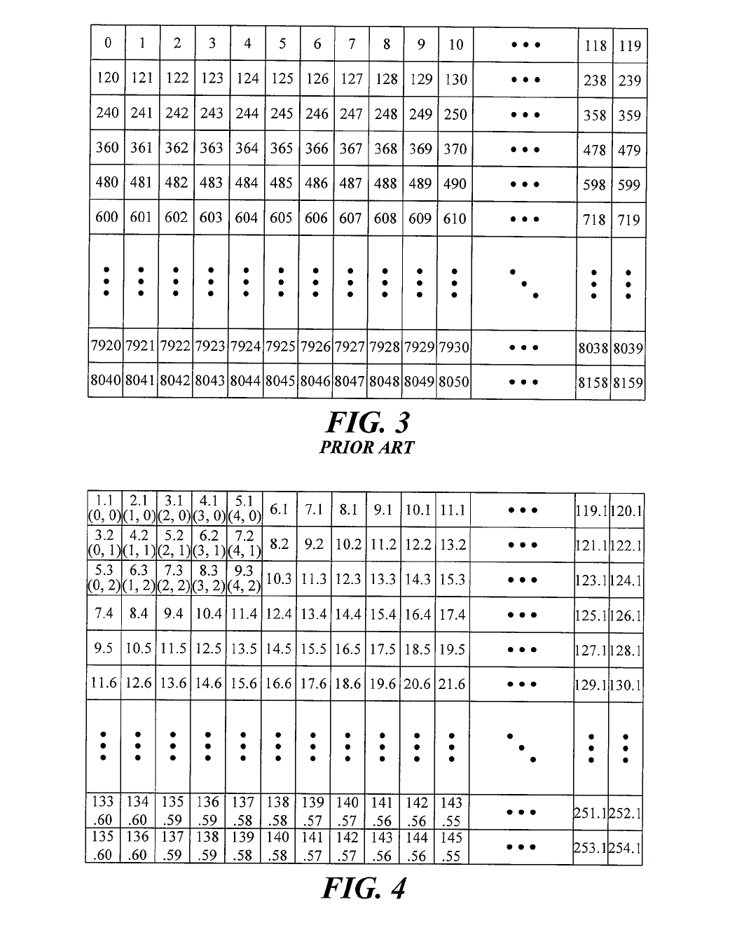

### DETAILED DESCRIPTION

The present disclosure describes systems and methods for processing video signals in an efficient manner. When a frame of video data is separated into macroblocks and intra-frame prediction processing is performed, the macroblocks can be grouped according to position and processed in parallel. In this way, the present disclosure provides embodiments that can process two or more macroblocks at the same time, unlike the conventional method that processes macroblocks one at a time. Using the parallel processing systems described herein, the time needed to process macroblocks during intra-frame prediction calculations can be reduced, and can even be reduced by a factor of about 32 compared to the conventional technique of processing. In other words, it may be possible, utilizing the systems and methods described herein, to obtain a processing time of about 3% of the total processing time of the prior art.

FIG. 4 is a diagram showing an example of an arrangement of 120 macroblocks wide by 68 macroblocks high for a high-definition (HD) video frame, which contains a size of 1920 pixels wide by 1088 pixels high. The diagram also shows a new order in which the macroblocks are processed. In this example, the macroblocks are created as an array of pixels having a size of 16 pixels wide by 16 pixels high (16×16). Although an HD frame is used in these examples, it should be understood that the present disclosure can apply to a frame having any size, resolution, or aspect ratio. Also, although a macroblock dimension of 16×16 is used in these examples, it should also be understood that the present disclosure can apply to macroblocks having any suitable dimensions.

In order to determine which macroblocks can be processed at the same time, the dependencies of each macroblock are observed. For example, since an intra-frame prediction process for H.264 includes predictions based on the macroblocks having the relationship as described with respect to FIG. 2, a macroblock can be processed when the values of the depended-upon macroblocks are known or the relative dependency location is outside the border of the frame. Since the macroblock (0, 0) at the top left corner of the frame does not have any valid dependencies for prediction, it may include uncompressed values.

It can be observed that macroblocks in the second row can be processed at the same time as some of the macroblocks in the first row. Also, macroblocks in the third row can be processed at the same time as some of the macroblocks in the second row, and so on. Also, certain macroblocks within several sequential rows can be processed at the same time. For example, after macroblocks (0, 0) and (1, 0) are processed, macroblock (0, 1) can be processed since its dependencies are either known or outside the border of the frame. In this respect, macroblocks (2, 0) and (0, 1) can processed simultaneously, or substantially simultaneously. Also, macroblocks (3, 0) and (1, 1) can be processed simultaneously. It should further be observed that three macroblocks (4, 0), (2, 1), and (0, 2) can be processed simultaneously. As this pattern progresses, it can be seen that many macroblocks (up to 60 in this example) near the middle of the frame can be processed at the same time.

According to the H.264 standard, a 16×16 macroblock depends on the three adjacent macroblocks as explained herein. However, it should be understood that other dependencies may be relied upon. For example, a macroblock may be predicted using two other macroblocks, one to the left and one above. In this case or in a case using other possible dependency patterns or modes, the pattern of parallel processing can be adjusted accordingly to possibly allow an even greater level of processing parallelism.

In addition to the coordinate values of the macroblocks, as shown in parentheses, notation used in FIG. 4 also includes a number having a value before a decimal point and a value after the decimal point. The first number represents a “pass” number, where the pass as used herein refers to an opportunity during a certain time period that one or more macroblocks can be processed simultaneously. In this case, macroblocks having the same pass number can be processed in parallel using distinct processing units. The processing can involve encoding (compression) or decoding (decompression). The second number after the decimal point represents the number of the macroblock within the certain pass. For example, in the first pass, only 1.1 is processed. In the second pass, 2.1 is processed. In the third pass, 3.1 and 3.2 are processed. In the tenth pass, macroblocks 10.1, 10.2, 10.3, 10.4, and 10.5 are processed, and so on.

The pass number for a particular macroblock can be calculated using the following equation:

P=X+2Y+1 Eqn. 1

where P represents the pass number, and X and Y represent the coordinate position of the macroblock such that the upper left position is (0, 0), and X=0 and Y=0.

The total number of passes can also be calculated using the following equation:

N=W+2H−2 Eqn. 2

where N represents the total number of passes, W is the width of the frame in macroblocks, and H is the height of the frame in macroblocks.

The maximum level of parallelism, which represents the highest number of macroblocks that can be processed simultaneously, can also be calculated using the following equations:

When W+1>2 H:

L=H Eqn. 3

Otherwise:

L=INT((W+1)/2) Eqn. 4

where L is the maximum level of parallelism and INT(x) is the integer value of x.

For example, given that HD video is 1920 pixels wide and 1088 pixels high, and given that macroblocks are created having a size of 16×16, W would be equal to 120 and H would be equal to 68. For macroblock (5, 3) where X=5 and Y=3, the pass number (P) for this macroblock, using equation 1, would be 12. The number of passes (N) for HD video, using equation 2, would be equal to 254, which is a large reduction in the number of passes compared with serial processing defined in the prior art, which requires 8,160 passes. Also, since W+1 is not greater than 2 H, then equation 4 can be used to calculated the maximum level of parallelism (L) for HD video, which in this case is equal to 60. Therefore, when 60 processing units are available and each is capable of processing a macroblock, then 60 macroblocks can be processed in parallel at the same time.

As can be observed from FIG. 4, the order that macroblocks are processed is changed from the conventional order. Instead of using a raster scan order, the order of macroblock processing is changed according to the pass numbers. The pass number, therefore, represents the order or sequence with respect to time. Macroblocks with a lower pass number are processed before those having a higher pass number. Macroblocks having the same pass number can be processed simultaneously. In addition to its common usage, the term “simultaneously”, as used in the present disclosure, can also mean “substantially simultaneously”, “overlapping in time”, or other variations as can be understood by one of ordinary skill in the art without departing from the spirit and scope of the present disclosure.

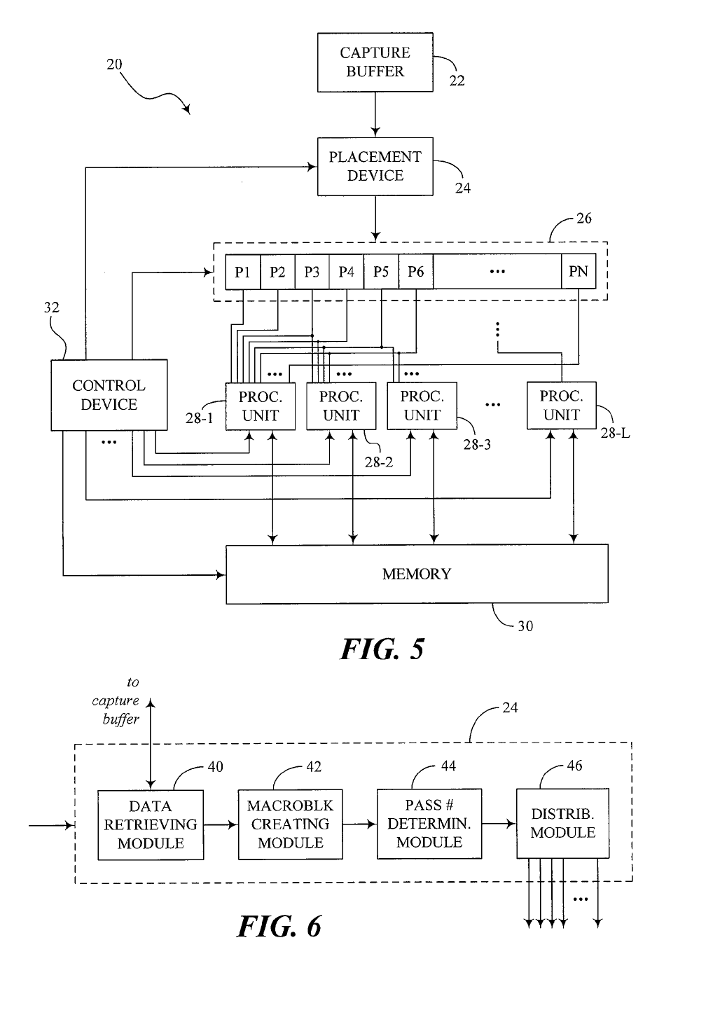

FIG. 5 is a block diagram of an embodiment of a macroblock processing device 20. In this embodiment, the macroblock processing device 20 includes a capture buffer 22 (which may be optional), a placement device 24, a buffer 26 referred to herein as a re-order buffer, processing units 28-1, 28-2, 28-3, . . . 28-L, memory 30, and a control device 32. The re-order buffer 26 includes a plurality of pass number registers P1, P2, . . . PN, each of which is capable of storing data for each of the macroblocks having the same pass number.

In some embodiments, the macroblock processing device 20 can be a data compression or data encoding device. In these embodiments, the capture buffer 22 can receive uncompressed video data directly from a video source, such as a video camera. Also, the processing units 28 can be data compression units or data encoding units to compress or encode the data for storage or for transmission to another location.

On the other hand, the macroblock processing device 20, in other embodiments, can be incorporated into a device that receives encoded or compressed video data and restores the video to a format for display on a display device. In these alternative embodiments, the macroblock processing device 20 can include a data decompression or data decoding device, and, in this case, the processing units 28 can be data decompression units or data decoding units. Also, as a data decompression or data decoding device, the capture buffer 22 may be omitted from these embodiments or may be replaced by an input buffer that receives the compressed or encoded data.

In FIG. 5, the capture buffer 22 receives video data, such as video data as captured in its original raw form. The video data is temporarily stored in the capture buffer until the placement device 24 can sort the data as needed. The placement device 24 receives the frames of data from the capture buffer 22 and creates macroblocks from each frame. The placement device may create macroblocks having any suitable size or dimension as needed, such 4×4, 4×8, 8×8, 8×16, 16×16, etc. When the macroblocks are created for a frame, the placement device 24 determines into which pass number register of the re-order buffer 26 the macroblock is to be placed. In this embodiment, the pass number register corresponds to the pass number of the respective macroblock. For example, a macroblock having pass number 3 will be stored in pass number register P3. The placement device 24 may calculate the pass number for each macroblock using equation 1 above, based on the position of the macroblock in the frame. In alternative embodiments, the pass numbers for the macroblocks in their respective positions can be pre-calculated and stored in a look-up table in the placement device 24.

The processing units 28 may operate at the same time that the placement device 24 places macroblocks into the pass number registers of the re-order buffer 26 and/or may operate after the placement device 24 has finished placing the macroblocks of the entire frame into the pass number registers. The control device 32 controls the particular pass number register to feed the macroblock(s) stored therein to the processing unit(s) 28. It should be recognized that the number of macroblocks in a pass number register is the number of processing units 28 that are utilized to simultaneously perform the processing. For example, the second number after the decimal point (FIG. 4) represents the number of that macroblock within a certain pass. This number can be used to determine which processing unit processes the particular macroblock. For example, for macroblock 18.5, this macroblock will be stored in pass number register P18 and retrieved from P18 by the fifth processing unit 28-5 for processing.

The pass number register P1, which stores only the first macroblock 1.1 (0, 0), sends macroblock 1.1 to the first processing unit 28-1 during the first pass. After the first processing unit 28-1 processes the macroblock, the values are supplied to memory 30. In embodiments where the processing units 28 are compression or encoding units, the compressed or encoded data in memory 30 can be supplied to a long-term storage device, e.g. DVD, or transmitted along appropriate transport channels, e.g. cable television communication channels. In embodiments where the processing units 28 are decoding (decompression) units, the decoded (decompressed) data can be temporarily stored in memory 30, which may be a frame buffer in this case, for display on a display device.

After the first pass, the control device 32 instructs the second pass number register P2 to feed processing unit 28-1 with the macroblock 2.1. In the next pass, the control device 32 instructs the third pass number register P3 to feed the first two processing units 28-1 and 28-2 with macroblocks 3.1 and 3.2. In this way, the two processing units 28-1 and 28-2 can process these macroblocks simultaneously. This is repeated N times, where N is the number of passes as determined in equation 2 above. However, if the re-order buffer 26 does not contain enough pass number registers to handle the maximum level of parallelism (L) as calculated in equation 3 or 4 above, or if the number of processing units 28 is less the maximum level of parallelism (L), then the control device 32 can separate a pass into two or more passes and allocate the pass number registers and processing units 28 accordingly.

As illustrated in FIG. 5, the pass number registers are connected to the processing units 28 in a predetermined manner. For example, every pass number register is connected to the first processing unit (28-1). Also, each pass number register can be connected to a number of processing units 28 equal to the number of macroblocks in the particular pass. Therefore, only the pass number register(s) having the maximum number (L) of macroblocks are connected to the last processing unit 28-L. In alternative embodiments, however, the allocation of the macroblocks to the processing units 28 may be changed to more evenly spread the load among the processing units 28. In this case, the connections between the pass number buffers and the processing units 28 may be altered from the illustrated arrangement.

When the processing units 28 are processing a macroblock that includes calculations based on already calculated macroblocks, then the processing units 28 can access the dependency data from memory 30 as needed. Each processing unit 28 is configured to retrieve data pertaining to a previously processed macroblock from memory 30. Generally, the placement device 24 is configured to place the macroblocks in respective registers based on an ability of a processing unit 28 to access data of previously processed macroblocks from memory 30. In accordance with Standard H.264, for example, when a processing unit 28 is processing macroblock (3, 2), the processing unit 28 can access the data related to macroblocks (2, 2), (3, 1), and (4, 1). In other embodiments, other dependencies may apply and therefore data from other relative macroblocks can be accessed from memory 30.

FIG. 6 is a block diagram of an embodiment of the placement device 24 shown in FIG. 5. In this embodiment, the placement device 24 includes a data retrieving module 40, a macroblock creating module 42, a pass number determining module 44, and a distribution module 46. In alternative embodiments, the placement device 24 may include other combinations or arrangements of components for sorting macroblocks and placing macroblocks according to position of the macroblock within the video frame. In the embodiment illustrated in FIG. 6, the data retrieving module 40 retrieves data from capture buffer 22, which, for example, may contain digital video data containing image signals of captured images. The data retrieval module 40 also receives an indication of the size, dimensions, or resolution of the images. The data retrieval module 40 forwards the data to the macroblock creating module 42, one frame at a time. The macroblock creating module 42 creates macroblocks from the video frame and assigns coordinates to each macroblock indicating the position of the macroblock within the frame.

The pass number determining module 44 receives the macroblocks and determines a pass number from their coordinates to sort the macroblocks according to a pre-arranged or determinable order. The pass number, as mentioned above, refers to the order or sequence in which the macroblocks are to be processed, wherein, during each pass, one or more macroblocks can be processed. Processing may involve any type or combination of operations or functions. For example, the processing may involve compressing the video data according to particular standards or specifications. The pass number determining module 44 can base the calculation of the pass number on the coordinates of the macroblocks and the dependency of the macroblock on other macroblocks having a predefined positional relationship to the macroblock to be processed.

The distribution module 46 receives the macroblocks, along with the coordinates of the macroblocks and pass number of the macroblocks. Then, the distribution module 46 distributes the macroblocks to certain pass number registers of the re-order buffer 26 shown in FIG. 5. In this way, the macroblocks are sorted according to their dependencies on other macroblocks and their ability to be processed at a certain time. The distribution process can be based on the pass number determined by the pass number determining module 44.

The macroblock processing device 20, including its components, as described in the present disclosure with respect to FIGS. 5 and 6, can be implemented in hardware, software, firmware, or a combination thereof. In the disclosed embodiments, the macroblock processing device 20 can be implemented in software or firmware that is stored in a memory and that is executed by a suitable instruction execution system. If implemented in hardware, as in other alternative embodiments, the macroblock processing device 20 can be implemented with any combination of discrete logic circuitry, an application specific integrated circuit (ASIC), a programmable gate array (PGA), a field programmable gate array (FPGA), etc.

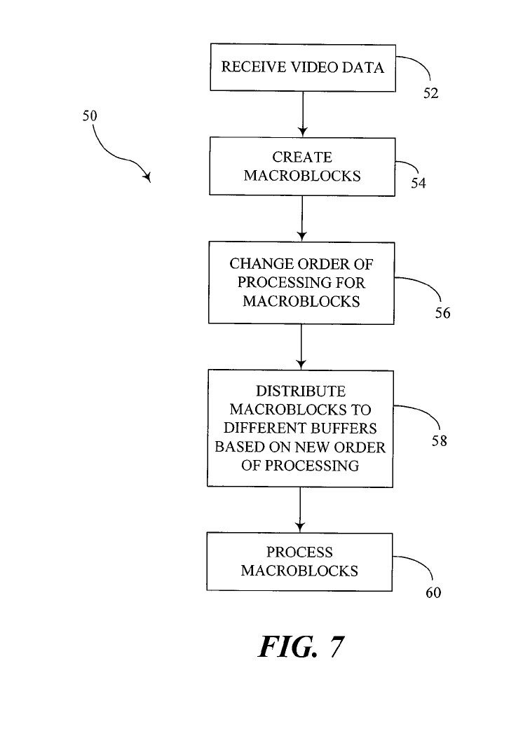

FIG. 7 is a flow chart illustrating an embodiment of a method 50 for processing macroblocks according to the teachings described herein. The processing method 50 includes receiving video data, as indicated in block 52. The video data may be data that is captured by a video capture device or may be previously stored in compressed form. Also, block 52 may include receiving the video data one frame at a time. Alternatively, the video data can be separated into frames in block 54. From each frame of video data, macroblocks are created, as indicated in block 54. For example, the macroblocks can be created with any suitable size, such as an array of 16×16 pixels.

In block 56, the order in which the macroblocks are to be processed is changed. This re-ordering procedure provides an order that is different from a conventional raster scan pattern that starts from the top left corner, moves from left to right along a scan line, and proceeds row by row until the last position at the bottom right corner is reached. The new order established in block 56 can be based, for example, on an earliest possible time at which a macroblock can be processed according to the dependency of the macroblock on the data from other macroblocks that have been processed at an earlier time. In addition, the new order can be based on the position of the macroblock within a frame.

In block 58, the macroblocks are distributed to different buffers based on the new order determined in block 56. For example, macroblocks to be processed at the same time can be sent to the same buffer. In block 60, the macroblocks are processed in the order determined in block 56. The order may also be established such that two or more macroblocks, such as macroblocks stored in the same buffer (block 58), can be processed simultaneously. In this respect, the processing can be defined as parallel processing since two or more macroblocks can be processed simultaneously by different, or parallel, processing units.

The flow chart illustrated in FIG. 7 shows a macroblock processing method, which can include an architecture, functionality, and operation of suitable macroblock processing software. In this regard, each block represents a module, segment, or portion of code, which comprises one or more executable instructions for implementing the specified logical function(s). It should also be noted that in some alternative implementations, the functions noted in the blocks may occur out of the order noted in FIG. 7 or may be executed substantially concurrently. In some cases, the blocks may be executed in the reverse order, depending upon the functionality involved, as would be understood by one having reasonable skill in the art.

In some embodiments, the methods may represent a macroblock processing program, which can comprise an ordered listing of executable instructions for implementing logical functions. The program, for example, can be embodied in any computer-readable medium for use by an instruction execution system, apparatus, or device. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, semiconductor, or other suitable system, apparatus, device, or propagation medium.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

I claim:

1. A system for managing macroblocks, the system comprising:
a placement device configured to create a plurality of macroblocks from a frame of video data;
a buffer separated into a plurality of registers, each register configured to store at least one macroblock;
a plurality of processing units, each processing unit configured to process at least one macroblock; and
memory configured to store results of macroblock processing performed by the processing units;
wherein the placement device is further configured to place the macroblocks into respective registers of the buffer based on the position of the macroblocks within the frame.

2. The system of claim 1, wherein the placement device comprises:
a data retrieving module for retrieving video data;
a macroblock creating module for creating macroblocks from a frame of video data;
a pass number determining module for determining a number of a processing pass for a macroblock to indicate when the macroblock can be processed; and
a distribution module for distributing the macroblocks to respective registers based on the respective pass numbers.

3. The system of claim 2, wherein the processing units are further configured to simultaneously process two or more macroblocks having the same pass number.

4. The system of claim 1, further comprising a control device configured to instruct a register storing two or more macroblocks to transmit the macroblock to different processing units.

5. The system of claim 4, wherein the different processing units are able to process the macroblocks simultaneously.

6. The system of claim 1, wherein each processing unit is configured to retrieve data pertaining to a previously processed macroblock from memory.

7. The system of claim 6, wherein the placement device is further configured to place the macroblocks in respective registers based on an ability of a processing unit to access data of previously processed macroblocks from memory.

8. The system of claim 1, wherein the placement device is further configured to place the macroblocks in respective registers based on an ability of two or more macroblocks to be processed simultaneously.

9. The system of claim 8, wherein the ability of two or more macroblocks to be processed simultaneously is based on dependencies of the two or more macroblocks upon data from other previously processed macroblocks.

10. The system of claim 1, wherein the position of the macroblocks within the frame determines the dependencies of the macroblocks upon data from other previously processed macroblocks during an intra-frame prediction calculation.

11. The system of claim 1, wherein the system is embodied in an encoding device configured to compress video data.

12. The system of claim 1, wherein the system is embodied in a decoding device configured to decompress video data.

13. A method comprising:
providing a frame of video data separated into a plurality of macroblocks, the macroblocks arranged in a raster scan order;
changing the order that the macroblocks are to be processed, the order being changed from the raster scan order to a new order, the new order including processing at least two macroblock simultaneously; and
processing the macroblocks in the new order.

14. The method of claim 13, further comprising:
distributing the macroblocks to a plurality of registers based on the new order, wherein macroblocks stored in the same registers are processed simultaneously.

15. The method claim 13, further comprising:
calculating a pass number for each macroblock, the pass number representing the sequence in which the macroblocks are processed.

16. The method of claim 15, wherein the pass number P is calculated using the equation P=X+2Y+1, where X and Y are the coordinates of a respective macroblock within the frame.

17. The method of claim 16, wherein processing the macroblocks further comprises processing the macroblocks having the same pass number substantially simultaneously.

18. The method of claim 13, wherein processing the macroblocks further comprises accessing data related to previously processed macroblocks upon which a macroblock to be processed depends for intra-frame prediction.

19. The method of claim 13, wherein processing the macroblocks includes compressing the data of the macroblocks.

20. The method of claim 13, wherein processing the macroblocks includes decompressing previously compressed data of the macroblocks.
